(19) United States
(12) Patent Application Publication
(10) Pub. No.: US 2015/0063777 A1
(43) Pub. Date: Mar. 5, 2015

(54) PERSONAL RECORDING AND DATA TRANSMITTING APPARATUS

(71) Applicant: OpLight LLC, Nottingham, MD (US)

(72) Inventor: Cam M. LETKE, Nottingham, MD (US)

(21) Appl. No.: 14/484,940

(22) Filed: Sep. 12, 2014

Related U.S. Application Data
(63) Continuation-in-part of application No. 13/894,883, filed on May 15, 2013.
(60) Provisional application No. 61/790,644, filed on Mar. 15, 2013.

(51) Int. Cl. H04N 5/77; H04N 1/21; A42B 1/00; H04N 5/225

(52) U.S. Cl. CPC H04N 5/772; H04N 5/2256; H04N 5/2252; H04N 1/2112; A42B 1/004; H04N 2101/00
USPC 386/224

(57) ABSTRACT

Described is a wearable personal illumination/recording device. The device includes, among other features, a rigid support, a housing coupled to the rigid support, an audio/video recording device, such as a high-definition video camera capable of transmitting live or recorded signals to remote displays or recipients, a light source, and an energy source. The light source may be an LED spotlight. The storage device housing may include a storage device slot for receiving a removable storage device. A wireless module may provide for connecting the recording device to a wireless network. The device may also include a microphone coupled to the housing, an ear bud for receiving real-time audio feedback from a remote recipient, a control panel including at least one indicator light, and a remote control for controlling at least one function of the personal illumination/recording device.

### RELATED APPLICATION

This application is a continuation-in-part of and claims the benefit of U.S. patent application Ser. No. 13/894,883, filed on May 15, 2013, which is based on and claims the benefit of U.S. Patent Application No. 61/790,644, filed Mar. 15, 2013, the contents of which are incorporated herein by way of reference.

### BACKGROUND OF THE INVENTION

1. Field of the Invention

The present invention relates generally to personal hands-free recording devices arranged on a head gear structure, such as a cap, helmet, hat or visor, with an occupational work light and audio/video recording and transmitting device for use in a variety of applications and industries, including surveillance, medical, sports, education/training, as well for governmental and personal use.

2. Description of the Related Art

The use of personal portable illuminating devices is well known. U.S. Pat. No. 5,541,816, for example, appears to teach a light source, attachable through brim hole by threaded rod/nuts (32), with battery housing above the brim and light source below, where the light source can rotate 360° around a horizontal axis, and up to 180°, arcuately, along a saggital plane. The device is taught to be attached to a hat, in multiple locations, a shirt lapel, a tent flap, a belt, etc., and can be attached by clip, by through pins, or through a brim using a threaded connection. Similarly, U.S. Pat. No. 8,002,437 appears to teach using one or more LED lights and a sub-body portion coupled within a guide channel of the main body, clipped to a hat, where the sub-body can slide laterally back and forth within the guide channel, relative to the main body, and can rotate arcuately some 100°+ along a saggital plane.

In another example, U.S. Pat. No. 7,431,472 appears to disclose a flexible light assembly mountable to the underside of the brim of a hat. The light assembly includes a light emitter, means for powering the light emitter and means for controlling the emission of light. The assembly is provided on a flexible member, which bends about or along the longitudinal axis of at least one surface defined by a hat. U.S. Pat. No. 7,506,992 appears to disclose a clip-on LED light assembly which is removably attachable to a hat brim, visor or the like. The LED light assembly has a plurality of LED lights located in a housing which is attached to the brim of a hat via spring clips. The light assembly may include a battery inside the housing and electronic circuitry in the housing responsive to the power switch.

Uses of personal illuminating devices are widespread, including uses in the medical device market. Indeed, traditional loupes worn by surgeons provide both illumination and magnification, both of which are necessary for surgery and have been in use for decades. Other inventions for surgeons include U.S. Pat. No. 7,370,991, which appears to disclose a voice-controlled surgical lighting assembly which is attached to the user's head via a strap. The lighting assembly is driven by a motor assembly which is controlled by voice activation, such that the user can control where the light is focused along an x-axis, y-axis and z-axis by speaking commands directed to the device. The assembly may include a rechargeable power supply source electrically coupled therewith. Similarly, U.S. Pat. No. 7,192,151 appears to disclose a surgical head gear apparatus which includes a lighting system that utilizes LED clusters mounted to a circuit board supported on the head gear. The lighting system may be self-contained with its own power supply, or electrically connected to an external power supply and controller, such as a controller associated with a ventilation system incorporated into the head gear.

The use of various recording devices during surgery is also well known in the art, such as the use of cameras for recording surgical procedures for historical and educational purposes. All of the above-referenced devices teach a lighting apparatus, but fail to teach or contemplate any sort of personal portable audio/video recording and transmitting device integrated into a lighting apparatus or assembly.

Personal audio/video recording devices are well known in the art. They have uses in a variety of industries and applications, including, for example, the security industry. A number of companies have designed hidden video recorders, often integrated into something the user may wear on his or her body, to allow for convenient and concealed audio/video recording. One such example is the Esky hidden video recorder, sold by HisGadget, Inc. of Union City, Calif. This device is designed as a pair of sunglasses, which incorporates an audio/video recorder and micro-SD slot into the sunglasses' frame. Similarly, KJB Security Products, Inc. of Nashville, Tenn. sells a hat having a high-grade video camera and digital video recorder hidden in its interior lining. The camera's lens extends through a small pinhole in the lining, allowing for concealed recording in the spy and surveillance industry.

Simpler devices which do not require hidden or concealed recording have also been developed. For example, iRes Technology Corporation of Markham, Ontario, Canada, has developed the uCorder device, a wearable mini recording device with built-in memory. The device provides built-in flash memory, as well as a USB interface and micro-SD slot for added storage capability. It has an audio/video camera which can capture up to six hours of recorded footage. It is designed to be clipped onto a shirt pocket, attached to clothing with a pin, or worn around the neck. Similarly, VieVu LLC of Seattle, Wash., offers a full line of “LE2” wearable cameras which may be clipped onto a police or security uniform to record the actions of the wearer. The camera includes proprietary software which securely stores and manages the video files.

While all of these devices incorporate some form of audio/video recording device into something that can be easily worn by the user, they do not provide for automatic transmission of the recorded data to an external device or recipient.

Integrating information transmission devices into articles of clothing and/or accessories is a developing area in the art. Currently, Google Inc. is developing a pair of augmented “reality” glasses which are to be worn by a user like a pair of regular glasses. These glasses have a clear display that sits above the eye and projects information into the user's line of sight. The glasses can be used to connect to the Internet, displaying information such as weather and map directions, and can also connect to the user's personal account, displaying incoming text messages and calendar reminder alerts. These glasses are designed to allow the user to be connected to the Internet at all times for optimal connectivity. However, in the prototype's early stages, the glasses do not provide any type of advanced illumination, nor are they necessarily designed to provide for continuous audio/video recording.

German-based company, o-synce, has developed a similar concept in its “screeneyeX” technology, which displays a constant readout of any information a user, typically a person engaging in physical activity, such as exercising, wishes to view. The electronics are integrated into the visor of a cap or similar head gear and project an LCD display in front of the user's left eye. The display is illuminated by way of a light collection film integrated in the visor. The unit can display a full range of training data, for example, including speed, distance, calories burned, and the like. This device, however, does not provide for real-time audio/video recording or transmission of recorded data.

Accordingly, a need exists for an integrated personal audio/video recording, illuminating, and data transmitting device that is unencumbered and efficient to use, and which has significant uses in all types of applications and industries.

### SUMMARY OF THE INVENTION

Accordingly, it is a principal object of the present invention to provide a personal and portable recording, illuminating, and data transmitting apparatus (hereinafter “personal recording device” or PRD, “personal illumination device” or PID, or “personal illumination and recording device” or PIRD) for use in a variety of situations and circumstances where audio-video recording and/or illumination of an area are important to a user.

Convenient and concentrated light sources are useful and efficient in any number of occupational or personal applications, including, for example, medical and surgical procedures, intricate repair work on small items, artistic work, such as painting, and the like. For instance, typical hospital operation room and medical office lighting does not provide the focused and intense light source necessary for detailed surgical procedures. Accordingly, attempts at portable, perhaps head-mounted, light sources abound. Any such portable light source must be positionable in nearly any desirable orientation as determined by the particular needs of the user. The light source must be focused and very illuminate, and must be rotatable in planes perpendicular to, and coplanar with, the general line of sight of the user. The portable light source, if attached to a wearable support device, must not hinder the manual dexterity of the surgical/medical user, and must maintain the sterility necessary in such an environment.

In addition to a light source, the incorporation of audio/video recording and transmitting capabilities drastically improves the utility of the wearable support device. Not only would such a combination provide a concentrated light source, but it could also allow its user to record his or her actions in real time and transmit those audio/video recordings to a secondary display or recipient, or record for later viewing.

Such a recording and transmitting device could be used in a variety of occupational applications and by a variety of professionals; examples include, but are not limited to, security/surveillance, law enforcement, emergency response, surgical procedure documentation, use by psychologists/psychiatrists (to record sessions with patients), news reporting, weather chasing, sports (to be worn by athletes, coaches, scouts/recruiters and the like), use by property inspectors/adjusters, bank clerks and other personnel, use in professional hunting/fishing, child care, use by photographers and videographers, use in “Do-It-Yourself” (DYI) presentations, use for occupational education/training, computer training, and the like. Such devices can also be used in a variety of personal applications; examples include, but are not limited to, personal safety, vacation/travel, exercise documentation, family events, nature watching, and driving safety. Companies and organizations can use such a device to assist with real-life advertising and marketing and to encourage customer reviews by allowing customers to record their experiences in real-time and share with others.

It is another object of the present invention to provide a PRD, PID, and/or PIRD for use by auto mechanics, hobbyists, jewelers, and/or anyone requiring a focused and bright light source with audio/video recording capabilities if needed, for detail work without encumbrance by shadow.

The foregoing is a non-exhaustive list of the types of uses and applications for which the PRD, PID, and/or PIRD would be advantageous, and it is not intended to limit the scope of the present invention.

It is another object of the present invention to provide a PRD, PID, and/or PIRD having a wearable support device and integrated devices that are waterproof and/or water resistant, resistant to contamination from bodily fluids, and made of washable material.

It is still another object of the present invention to provide for removal of the light/audio/video assembly, switches, and battery compartments/housings from the wearable support device for washing or maintenance.

Briefly described, those and other objects and features of the present invention are accomplished, as embodied and fully described herein, by a wearable (and thus portable) support device, such as a baseball-style cap, with integrated devices for recording audio and video information and providing illumination for video recording and personal task work, with data storage and transmission to and from the wearable support device.

The integrated illumination device may be a light source, attachable to the wearable support device. In the case of a device worn by a medical caregiver to illuminate work in a surgical/medical environment, the integrated illumination device may be an LED light and/or LED light cluster.

The light source is preferably constructed for mounting on the wearable support device, where the light source includes a light source housing having a threaded channel and cap for threaded, movable attachment of the light source housing through and to a brim of the wearable support device. The light source housing further preferably includes an arcuate track. The light source is also provided so that it slidably communicates with the arcuate track to provide directional rotatability of the light source about an axis perpendicular to a plane formed through and extending from a longitudinal axis of the arcuate track. The light source housing includes a threaded channel and cap for threaded, movable attachment of the light source housing through and to the brim of the wearable support device.

The integrated audio-video recording device may include an audio speaker and a video camera, with mechanism for attachment of the same to the wearable support device, and specifically, in the case of a baseball-style cap, to the brim of the cap, or to a front portion of a helmet, hard hat, or other hat used by any number of professionals or individuals engaging in various activities. The audio-video recording device also slidably communicates with the arcuate track to provide directional rotatability and maneuverability of the audio or visual recording device together with the light source.

An integrated energy source housing is also provided, electrically coupled to the light source housing, and includes an energy source for supplying energy to the at least one light source. According to one embodiment, the energy source housing and light source housing are formed together as one unitary body.

The objects and features of the present invention are also accomplished, as embodied and fully described herein, by a baseball-style cap wherein the light source is attached below the brim of the cap, attachable through a brim hole in the cap by threaded, male/female housing connection. The energy source or battery housing may be located in a remote location on the cap, either above the brim, along an edge of the brim, on or under the cap. The light source assembly could be capable of rotation up to 300° around a horizontal axis (relative to a user), and up to 180° (perhaps closer to 100°+), arcuately, along a saggital plane of the user. The light source device may be attached to the cap in multiple locations, and can alternatively be attached by clip, by through pins, or by the through brim threaded connection.

The light source may also include an infrared light source attached to the light source housing, a high-definition video camera attached to the light source housing and capable of transmitting live or previously recorded signals to any remote display or recipient, and an LED recording light attached to the light source housing, the recording light being activated when the high-definition video camera is activated. In this embodiment, the wearable support device includes a micro-SD port for receiving a micro-SD card, a wireless network antenna for connecting the high-definition video camera to a wireless network, a wireless network indicator light, and an energy source housing electrically coupled to the light source housing, including an energy source for supplying energy to the at least one light source and the high-definition video camera.

The objects and features of the present invention are also accomplished, as embodied and fully described herein, by a wearable personal illumination/recording device in the form of a baseball-style cap having a brim and crown portion. The personal illumination/recording device includes an audio/video recording device, which may be a high-definition video camera, stored within a light/camera housing which is coupled to a light/camera support structure. The light/camera support structured is received in a rigid support which is coupled to the underside of the brim of the wearable personal illumination/recording device. An energy source housing, which includes at least one initial energy source, is electrically coupled to the light/camera support structure for supplying energy to the audio/video recording device.

The personal illumination/recording device may further include at least one light source within the light/camera housing. The at least one light source may be an LED spotlight formed of two dome-shaped lenses curving away from each other with a clear silicone material injected between each lens.

The personal illumination/recording device may also include a storage device housing coupled to the light/camera support structure, behind the light/camera housing, which includes a storage device slot for receiving a removable storage device, such as a micro-SD card. The personal illumination/recording device may further comprise a wireless network antenna by which the audio/video recording device may transmit live or previously-recorded audio and/or video data to a remote display or recipient.

The personal illumination/recording device may further include other components, including a control panel having at least one indicator light, a microphone, an ear bud for receiving live audio feedback, a remote key fob for controlling at least one function of the personal illumination/recording device, and a display screen.

The present invention will be better understood with reference to the following description taken in combination with drawings of various embodiments of the invention.

### BRIEF DESCRIPTION OF THE DRAWINGS

For the purpose of illustration, there are shown in the drawings certain embodiments of the present invention. In the drawings, like numerals indicate like elements throughout. It should be understood, however, that the invention is not limited to the precise arrangements, dimensions, and instruments shown, and preferred embodiments of the invention are described for illustrative purposes. It should be understood that the invention may be embodied in other forms not specifically shown in the drawings.

FIG. 1 is a schematic drawing of an exploded view of a light source housing of a light source device of an embodiment of the present invention, the exploded view showing attachment of the light source device to a brim of a wearable support device;

FIG. 2 is a schematic drawing of a side view of an energy source housing of a light source device of an embodiment of the present invention;

FIG. 3A is a schematic drawing of an underside view of a track of a light support of a light source housing of a light source device of an embodiment of the present invention;

FIG. 3B is schematic cross-sectional drawing showing a view of the track illustrated in FIG. 3A;

FIG. 4 is a schematic perspective view drawing of a light source of a light source device of an embodiment of the present invention;

FIG. 5 is a schematic perspective view drawing of a baseball-style cap embodiment of a wearable support device of a light source device of the present invention;

FIG. 6A is a schematic perspective view drawing of another embodiment of a light source of the present invention, showing side attachments on the light source for additional components;

FIG. 6B is a schematic front view drawing of the light source illustrated in FIG. 6A;

FIG. 7 is a schematic front perspective drawing view of another hat embodiment of a wearable support device of a light source device of the present invention;

FIG. 8 is a schematic front view drawing of a light and audio/video recording assembly of an embodiment of the present invention;

FIG. 9 is a schematic block diagram of components of an apparatus in accordance with one aspect of the present invention;

FIG. 10 is a schematic block diagram of additional components of an apparatus in accordance with another aspect of the present invention; and

FIG. 11 is a process, data, and operations flow diagram showing various features of another embodiment of the present invention;

FIG. 12 is a schematic bottom view perspective drawing of a baseball-style cap of another embodiment of a wearable PID/PRD/PIRD of the present invention;

FIG. 13 is a schematic exploded bottom view perspective drawing of the wearable PIRD illustrated in FIG. 12;

FIG. 14 is a schematic bottom view drawing of the PID/PRD/PIRD illustrated in FIG. 12;

FIG. 15 is a schematic front view drawing of the PID/PRD/PIRD illustrated in FIG. 12;

FIG. 16 is a schematic back view drawing of the PID/PRD/PIRD illustrated in FIG. 12;

FIG. 17 is a schematic side view drawing of the PID/PRD/PIRD illustrated in FIG. 12;

FIG. 18 is a schematic diagram showing various features of the PID/PRD/PIRD according to the present invention;

FIG. 19 is a schematic cross-sectional view drawing of a light source in accordance with another aspect of the present invention; and

FIG. 20 is a schematic block diagram of additional components of the PID/PRD/PIRD according to the present invention.

### DETAILED DESCRIPTION OF THE INVENTION

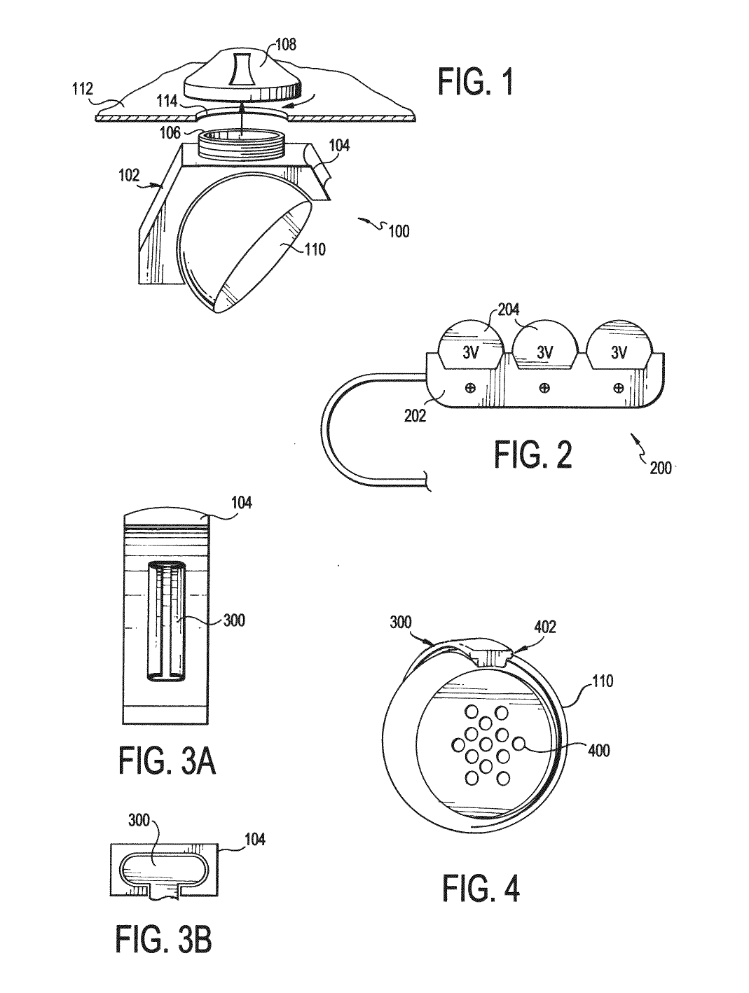

Turning first to FIG. 1, illustrated therein is one embodiment of a light source housing 102 of a PID 100 for illuminating an area, according to the present invention. The PID 100 of the present invention may generally be constructed of a wide variety of fairly rigid materials including, but not limited to, light weight metals, acrylics, polymers, and other polymeric materials.

The light source housing 102 includes a light support 104, a threaded channel 106, a cap 108, and at least one light source 110. The light source housing 102 may be made of any suitable material, such as a polymeric material prepared from a single or multiple molds and machined as necessary to achieve the shape shown. The material should be resistant to or impermeable to fluids, such as, for example, water and bodily fluids. Any such waterproof and water resistant materials known to one skilled in the art may be used, including, but not limited to Gore-Tex O, sold by W. L. Gore and Associates of Newark, Delaware. The light source housing 102 is capable of attachment to a brim 112 or other structure of a wearable support device (not shown) via a hole 114 in the brim 112 of the wearable support device.

The threaded channel 106 is placed through the hole 114 and is threadably secured to the cap 108. In an alternative embodiment, for example, with a wearable support device without a bill or brim 112, a forward-protruding member could support the light source housing 102, and could include a pivot, swivel joint, telescoping member and/or bendable (“memory”) member.

Turning now to FIG. 2, illustrated therein is one embodiment of an energy source housing 200 used in conjunction with the PID 100 of the present invention. The energy source housing 200 includes an energy source (battery) cartridge 202, and one or more batteries 204. The energy source preferably may be one or more lithium cell, coin-style batteries (providing an inexpensive, lightweight, easily replaceable energy source), or could be another type of battery system. A typical power output from a lithium battery source will be low voltage, on the order of a few volts. In another embodiment, the batteries 204 may be of a type similar to those found in most cell phones and smart phones, such that they have the same charging ports.

Turning now to FIGS. 3A-3B, illustrated therein are an underside view and a cross-sectional view, respectively, of a light support 104 of the light source housing 102 of the PID 100 according to the present invention. The light support 104 may be made of a suitable metallic or polymeric material that provides sufficient strength. The light support 104 may be arcuately-shaped and may include therein a track 300 for movable attachment of the at least one light source 110 relative thereto.

Turning specifically to FIG. 3B, shown therein is the track 300 having a “T” shape channel, including either a male or female component thereof. Other shapes are possible, such as ball and socket arrangement, or a “C”-shaped channel. The arcuately-shaped housing embodiment of the present invention is advantageous as the housing can secure the light source in place due to gravity, friction, and compressive forces, without a need for hooks, locking barbs, flanges, bolts, and/or locking tabs.

Now turning to FIG. 4, shown therein is the light source 110 having a circular-shaped enclosure, such as a dome, and can include therein the alternative male/female component 402 of the track 300. The track 300 is configured to provide smooth glide surfaces along the arcuate path thereof, but to also provide snug friction fit for tractable hold of the light source 110 to the light support 104. The arcuate track 300 provides directional rotatability of the light source 110 about an axis perpendicular to a plane formed through and extending from a longitudinal axis of the arcuate track 300. This plane would be the sagittal plane of a user donning the wearable support device with the light source device.

The light source 110 may include one or a plurality of light-emitting diodes (LEDs) 400, preferably one (1), but up to eight (8) or more LEDs arranged in an LED cluster. Other light sources are possible other than LEDs.

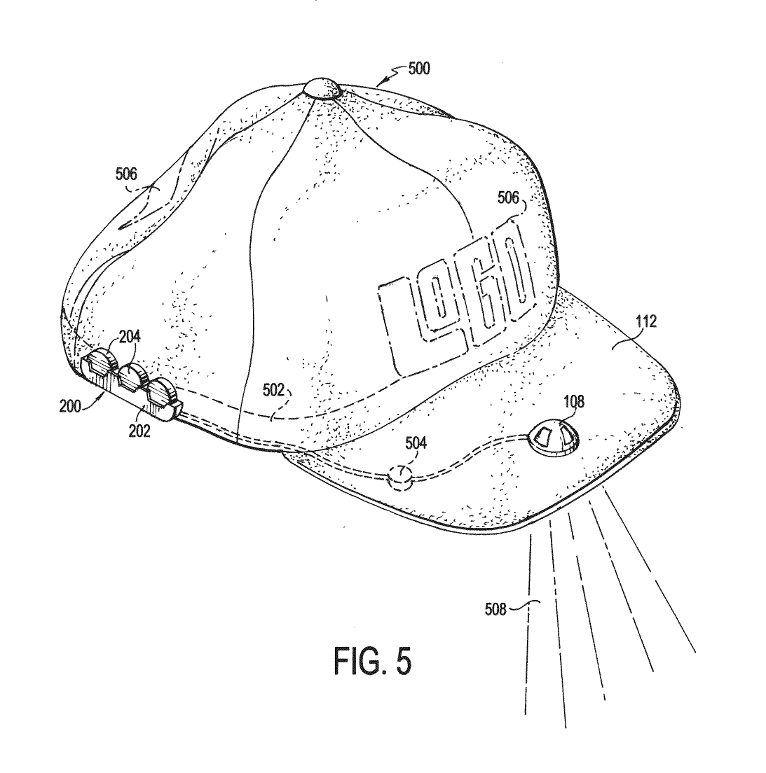

In one preferable embodiment, the light beam provided from the light source 110 will have a substantially equal width and height. The light beam will be bright and intense (even relative to a well lit environment), providing focused light for detailed work, without shadow. In one embodiment, a spotlight 2-inch in diameter is provided (see light beam 508 in FIG. 5)—one that projects a beam of 2.5-inches in diameter at a distance of 18-inches. In this or another embodiment, the light source 110 is a completely enclosed ball assembly, directing all light forward, in spotlight fashion, to the task at hand. According to yet another embodiment, the diameter of the light beam 508 may be adjustable.

Alternative embodiments of the present invention might include two or more light sources 110. These light sources might be intermittently attached to a cross-bar or support bracket that includes, perhaps centrally located thereon, the alternative male/female component of the track 300.

An additional light source might alternatively be a UV lamp, for illumination of fluorescent chemicals/stain/compounds and the like. The UV lamp may be substituted for the one or more LEDs by replacing the entire light source 110 with a UV light source, or the UV lamp may be combined with and integral with the one or more LEDs. Similarly, an additional light source might alternatively be an IR lamp for illumination in low and no-light environments, such as during the evening or indoors where ambient light is absent. The IR lamp may be substituted for the one or more LEDs by replacing the entire light source 110 with an IR light source, or the IR lamp may be combined with and integral with the LEDs.

As shown in FIG. 5, the wearable support device 500 may be a hat (e.g. baseball-style hat), or a hardhat, a visor, or open, strapped arrangement. The wearable support device 500 could be fitted, or adjustable, perhaps by including an elastic band 502 or clipped strap for adjustability and comfort.

At least a brim 112 of the wearable support device 500 could comprise an extruded plastic of sturdy construction, capable of supporting the light source housing 102. Or, the wearable support device could be a hat, or hardhat, either partially or entirely composed of polymeric materials, including recycled composite plastics.

The wearable support device 500 is water resistant and/or waterproof depending on its application, and could be made of a material that is resistant to contamination by bodily fluid, resistant to absorption of liquids, and is readily washable. In general, the wearable support device is made of material suitable and approved for a surgical/medical environment, which is sheer, washable and breathable (e.g. Blue material), and which also serves as protective headwear in a surgical and/or sterile environment (i.e., Personal Protective Equipment (PPE)).

The wearable support device 500 could further include an identification tag or chip (e.g., an ID chip, such as a RFID tag), for inventory control, or for location of the wearable support device within a particular environment.

In another embodiment of the invention, the wearable support device 500 could be a surgical head-gear assembly having pre-cut and formed holes for attachment and use of one or more components (e.g., LED spotlights, an audio/video recorder, mirror(s), energy source, and/or multiple setting switch apparata), some of which are described below.

The PID 100 may include an on/off switch 504 integral to the light source housing 102, to the energy source housing 200, or separate from each (as shown in FIG. 5). A separate arrangement, with on/off switch 504 attachment to the wearable support device by clip, pin, through-bolt, with placement in a location desired by the user, provides ease of use and ease of replacement (relative to the other electrical components). All electrical components and connections are water resistant and waterproof. Leads that electrically-connect components are hidden and integrated into the structure and materials of the wearable support device 500 such that they are not visible to the user but may be accessible, as necessary, for repair and replacement.

In one aspect, the wearable support device 500, or the brim 112 thereon, could include a respective user (or doctor's) name 506 stenciled on it (in cursive, like on the doctor's white coat), and/or a manufacturer's or hospital's logo 506. Any desired personalized information 506 may be included on the wearable support device 500.

In another aspect, also included is a battery recharging stand (not shown), such as an induction charging system or cradle with an integrated male plug connector, which is enabled by simply hanging the PID 100 (or hanging/attaching the wearable support device, or power source alone) on the cradle or a hook. Other methods of recharging are described below.

In further aspects of the present invention, the PID 100 further includes and/or incorporates (and/or the wearable support device 500 thereof provides for attachment of):
additional lamp(s) (whether visible, UV, and/or IR);
surgical or detail loupes (e.g., magnifying glasses), of the type well known in the surgical, watch and jewelry, and other arts;
one or more fans (for cooling the user's head and/or face);
mirrors (for increased visibility);
earpiece having Bluetooth® capability;
a larger battery compartment;
a small “heads-up” display screen (e.g., small 2-inch by 2-inch screen that displays a grid, task list, or vital signs of patient to a surgeon);
other audio/video capability (see further discussion below) for capturing/recording task activities and/or to provide a live feed to one or more remote monitors (included therewith would be a suitable memory device for capturing video feed—a small SSD, a removable micro flash stick, and/or be wired/wirelessly connected to a larger remote device having greater storage capacity (if wireless, could use Bluetooth® (standardized as IEEE 802.15.1), Wi-Fi, or other proprietary low voltage, low bandwidth transceiver device);
an accelerometer to determine a position of the PID 100 relative to a known location (e.g., the floor or other reference plain, e.g., the horizon); and/or
a chip interrogator, perhaps in the form of a handheld scanner (like a bar code scanner), or included in the hospital (OR) facility (e.g., to scan the chip when a user enters the OR).

Any of the additional components noted above, for attachment to the wearable support device 500, could be by any means previously described, such as male-female connectors, externally threaded attachment housing to a female internally threaded cap, or by a “push and twist” coupling, among others known in the art.

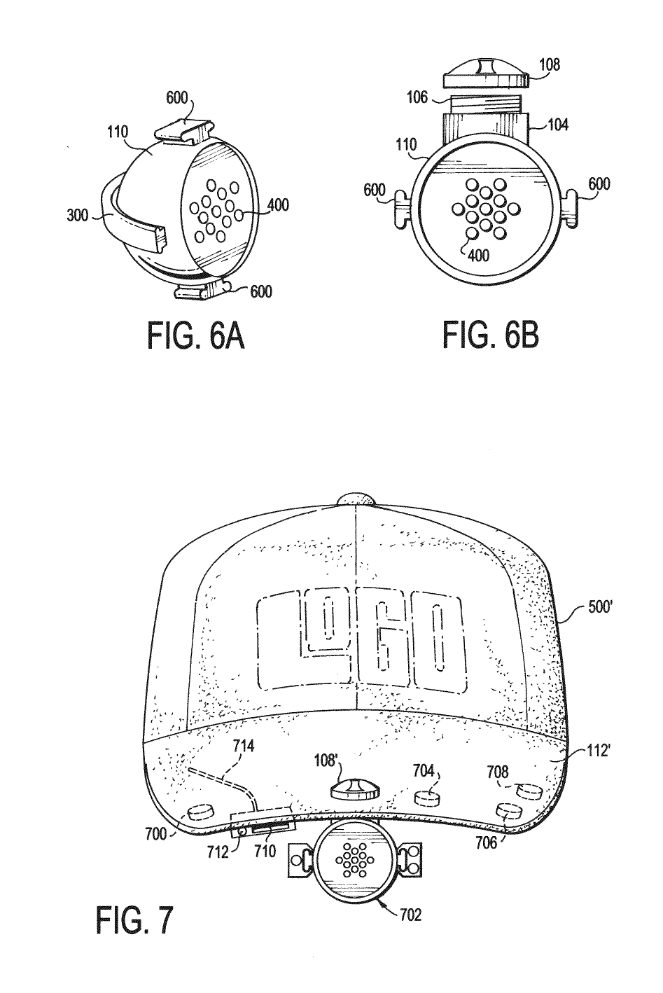

Any additional component, such as those described above, including, for example, a personal audio and/or video recording device, could similarly attach to the track 300, thereby providing for maneuverability together with the light source 110 (i.e., up to 300° rotation about a horizontal axis (relative to a user), and up to 180° (perhaps closer to 100°+), arcuately, along a saggital plane of the user). For any additional component, particularly if the additional component is a video camera, it is advantageous to mount the video camera to the light source see attachment points 600 on FIGS. 6A-6B), or in conjunction with the light source (e.g., by similar attachment to the track 300), so that both the light source and camera follow the same trajectory of movement during use, and so that the light source is directed to effective illumination of the subject matter to be recorded.

The attachment of the PID 100 and other components described above, in particular the personal audio and/or video recording device, are attached via an arcuate track in such a way to provide directional rotatability of the light source about an axis perpendicular to a plane formed through and extending from a longitudinal axis of the arcuate track. In that way, it provides a useful way for the user to project light onto an area at an angle that is parallel to the user's general line of sight such that the user may maneuver his or her head to adjust the direction of the light being projected onto an area of interest. Thus, for example, in the case of a surgeon performing a surgical procedure, he or she could don the wearable support device 500, manually aim the PID 100, and from that point forward aim the PID 100 by simply moving his or her head in small increments, never having to touch the PID 100 during the procedure. Similarly, the personal audio-video recording device, described below, could be aimed such that it records the user's actual field of view, effectively capturing a “day in the life” of the user (i.e., everything the user sees visually is captured by the video camera, and everything the user hears is captured by the audio microphone).

Thus, the PID 100 may be replaced by one or more personal audio and/or video recording devices, each controlled by one or multiple switches, thereby allowing the light of the PID 100 to be in an on/off or high/low setting while the personal audio-video recording device separately functions in an on/off and Bluetooth®/Wi-Fi/micro-SD card setting, as further described below.

Further, the audio device could be hands free, and used to activate other devices by voice recognition, of either the light source or the audio/visual recording device. Voice recognition may be implemented as a software process by the run-time software on the PID 100, either with pre-determined commands and word or phrase library stored in memory, or “trained” to recognize the user's particular voice.

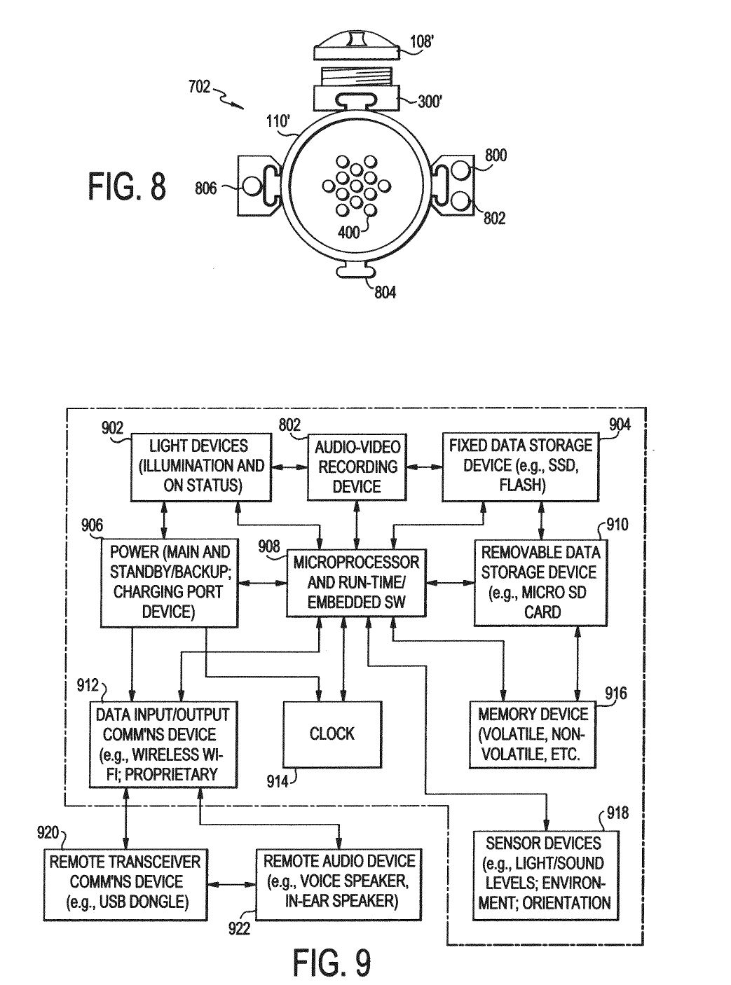

Turning now to FIGS. 7 and 8, another embodiment of the present invention is described, in particular a wearable support device 500, depicted as a hat (although not limited to such a design or form factor). The wearable support device 500′ may include a personal illuminated audio/video recording device (PIRD) or personal recording device (PRD) 702. Essentially, the PIRD/PRD 702 combines the functionality of a light and an audio and/or video recording mechanism into one assembly. The wearable support device 500 may comprise other components discussed herein to assist the user in various tasks. For example, the wearable support device 500 may include switches to activate the various lighting and recording functions, such as an audio/video recording switch 700, a light source (LED) on/off switch 706, and an infrared on/off switch 708. According to one embodiment, each of the switches 700, 706, 708 is attached to the underside of the brim 112 of the wearable support device 500. According to an alternative embodiment, each of the switches 700, 706, 708 is mounted integrally together as one switch component.

The wearable support device 500 may include a microphone 704 to provide concentrated audio signals to be captured by the recording device. The microphone 704 may be connected to the video component of the audio/video recording device 802 via hardwire.

The wearable support device 500 may include a micro-SD port 710 for housing a micro-SD card (not shown) for audio/video storage capabilities. The wearable support device 500 may have a storage indicator light (not shown) which alerts the user when the storage available on the micro-SD card (or whatever alternative storage is being used) falls below a pre-set threshold. Alternatively, the wearable support device 500 may be designed to connect to an external digital-video recorder (DVR) module which could be carried separately from the wearable support device 500 by the user.

Accordingly, the PIRD/PRD 702 of the present invention may allow a user to illuminate, observe, record, and transmit audio and/or video enabling hands-free use for multiple occupational or personal tasks, thereby providing proper observation and recordation of any live activity. This functionality also provides that a user can receive educational or technical guidance while performing a task (receiving guidance from another at a remote location) and also provides that a user could provide explanation of, or education concerning, the task to another at a remote location in real time while performing the task. The present invention thereby also provides a very efficient educational and teaching apparatus.

Still further, the PIRD/PRD 702 may include an attachment mechanism in a vicinity of the ear of the wearable support device 500 for an earpiece providing that an audio phone conversation can occur, or could be private to the user, and not announced to surrounding ears. This could be in addition to a two-way speaker/microphone that could be attached to a brim of (or elsewhere on) the wearable support device 500 for teaching purposes (or questions and answer sessions) with remote individuals. The Bluetooth®/two-way audio capability is advantageous for mandatory or emergency communication occurring while the user is in surgery or performing any given task. Video recordation of the task could be also be used as later evidence of the task, and how the task progressed.

In a preferred embodiment, the wearable support device 500 may include a wireless network Wi-Fi antenna 714 for connecting to a wireless network to transmit audio/video signals in real-time, or those that have been previously recorded. In this embodiment, the wearable support device 500 also includes a Wi-Fi indicator LED light 712 so the user (and those individuals in his/her vicinity) can easily discern when the wearable support device 500 is connected to a wireless network.

In FIG. 7, the Wi-Fi antenna and Wi-Fi indicator LED light are located under the brim 112 so as to allow them to be protected from environmental elements, but they may be located anywhere on the wearable support device 500.

According to alternative embodiments, the wearable support device 500 could be a visor having a strap that runs around the back of the user's head to hold the visor in place. A visor having arms (such as the arms on a pair of eyeglasses) could also be used, instead of having strap that runs behind the head. The PIRD/PRD 702 could be coupled to a visor in the same ay as it is coupled to the wearable support device 500. Preferably, the wearable support device 500 and all of its components are water resistant and waterproof. Together, the energy source (not shown) of the wearable support device 500 is designed for up to ten hours of continuous run time.

As shown in FIG. 8, the PIRD/PRD 702 provides the user with a compact and integrated illumination, recording and transmitting device. The PIRD/PRD 702 generally includes an LED light source housing 110 including at least one white LED 400, preferably a plurality of LEDs 400 arrayed in a suitable pattern, an IR light 800, an audio/video recording device 802 (preferably a high-definition video camera), and an LED recording light 806. According to one embodiment, the LED light source housing 110, the IR light 800 and audio/video recording device 802 are connected such that they move together in unison and are coaxial with the line of sight of the user.

The infrared light 800, audio/video recording device 802 and LED recording light 806 may be attached to the light source housing 110.

The at least one LEDs 400 located within the LED light source housing 110 provide the illumination the user may need to perform detailed tasks and generally provide lighting in dark environments. According to one embodiment, the at least one LEDs 400 are designed as variable-focus adjustable spotlight(s). These spotlights allow for adjustment of the diameter of the light beam, to make it wider or narrower depending on the needs of the user.

The IR light 800 may be used for any number of purposes, including as a night vision feature to assist in surveillance/security applications.

The audio/video recording device 802 of the PIRD/PRD 702 is used as the recording function of the wearable support device 500 and is controlled via the audio/video recording switch 700. The audio/video recording switch 700 operates continuously, meaning that when it is pressed once, the recording device 802 is turned on, and when it is pressed again, the recording device 802 is turned off. Each time the recording device 802 is activated to begin recording, a new clip is created. According to one embodiment, the audio component and video component, individually, of the audio/video recording device 802 may be mounted separately onto the wearable support device 500.

The user is notified when the recording device 802 is recording via the LED recording light 806. This recording light 806 is visible from both the user's view and the outside view, so individuals in the vicinity of the user may discern when the recording device 802 is recording.

The PIRD/PRD 702 may attach to the wearable support device 500 in the same manner as other embodiments discussed herein. Specifically, the PIRD/PRD 702 includes a threaded cap 108, which engages a female arc track housing 300 that extends through a hole located in the brim 112 of the wearable support device 500 (or visor). In this way, the PIRD/PRD 702 may rest under the brim 112′ of the wearable support device 500 (or its visor). The PIRD/PRD 702 also includes a male track mating portion 804 which engages the female arc track housing 300′ so as to releasably secure the device 702 to the female arc track housing 300′.

The LED light source housing 110′ can be arcuately shaped and can be movably attached to the female arc track 300′. The arc track 300′ can be “T” shaped, including either a male or female component thereof (shown as female component in FIG. 7). Other shapes are possible, such as ball and socket arrangement, or “C” channel, as previously discussed. The arcuately-shaped track embodiment of the present invention is advantageous as it can secure the LED light source housing 110′ in place due to gravity, friction, and compressive forces, without a need for hooks, locking barbs, flanges and/or locking tabs.

The LED light source housing 110′ can have a circular shaped enclosure, such as a dome. The female arc track 300′ is configured to provide smooth glide surfaces along the arcuate path thereof, but to also provide snug friction fit for tractable hold of the LED light source housing 110′. The female arc track 300′ provides directional rotatability of the LED light source housing 110′ about an axis perpendicular to a plane formed through and extending from a longitudinal axis of the female arc track 300′. This plane would be the sagittal plane of a user donning the wearable support device 500 with light source device.

According to one embodiment, the energy source housing (not shown) may be mounted within the wearable support device 500, such as within a lining or pocket of the wearable support device 500. Preferably, the energy source housing is easily removable for repair and replacement. Like all other components, the energy source housing (not shown) is waterproof and water resistant when mounted in any configuration. According to yet another embodiment, the energy source housing (not shown) and the LED light source housing 110′ are formed together as one unitary body.

Turning now to FIG. 9, shown therein is a block diagram of electronic hardware and software components and features of one embodiment of the PID/PIRD/PRD 702 (in this embodiment, those components and features are shown inside the dashed line in the figure). In particular, the embodiment shown includes a light device 902, audio/video recording device 802, fixed data storage device 904, power supply device 906, microprocessor 908 device, removable data storage device 910, data input/output communications device 912, internal clock 914, memory device 916, and one or more sensor devices 918. Also shown in FIG. 9 is a remote transceiver communications device 920, and remote audio device 922.

The light device 902 preferably includes one or more white LEDs 400′, as previously described, arrayed within light source housing 110′ in a suitable pattern (including as a single “pin-light” diode, or multiple diodes such as in a 2×3×2 array) to maximize the luminous output by the light devices 400′, taking into account the power supply (more LEDs will demand more power). The diodes are selected to provide a white balance optimal for maintaining true color resolution when taking color video. The light device 902 also includes IR lights 800, selected to provide optimal use of the video camera during low or no-light conditions, as previously discussed.

The audio-video recording device 802, as previously described, consists of a CCD or CMOS sensor chip with a number of pixels as suitable for a given use. For example, a 300,000 pixel array may be used (which may produce an image size of about 640×480), or an array of 10 million pixels (which may produce a much larger image size).

The lens of the audio-video recording device 802 may be any suitable lens with a wide viewing angle and zoom (both parameters adjustable using software). Any suitable video format is contemplated, including various well-known compressed video file formats, especially those that provide for real-time buffered streaming. The recording speed may vary, including up to 25 frames per second, but higher and lower image (frame) capture rates are contemplated.

The audio-capture portion of the audio-video recording device 802 should provide for capturing audio preferably up to 10 feet from the microphone, although the device could also capture and record sound up to 20-25 feet from the microphone.

The fixed data storage device 904 may be, for example, a solid state device (SSD) with a pre-determined storage capacity, such as 1 GB (depending on a particular application).

The power supply device 906 may be, for example, one or more rechargeable (non-serviceable) batteries 204, such as lithium batteries previously described, or replaceable (serviceable) batteries, to produce the necessary power to operate the devices described herein. Preferably, power consumption is managed to provide a battery life of up to 8-10 hours, depending on the specific use. A charging port (for receiving a charging plug (connected to a cable; not shown) may be included for charging the batteries.

The microprocessor device 908 is embedded on a printed circuit board (not shown) or otherwise deployed as would be customary for such an application as shown and described herein. The microprocessor communicates with and is made operable by embedded software necessary to facilitate the collection and transfer of data, and other run-time features of the devices described herein. Such software, otherwise known as firmware, will be embedded or stored in memory, or otherwise deployed on the PIRD/PRD 702, and may be updated via wire or wirelessly in a manner well known in the art, and may be updated either manually or automatically whenever updates become available.

The removable data storage device 910 may be, for example, a micro-SD card as previously discussed, or other suitable portable storage device, for storing data up to, for example, 8 GB. That amount of storage is equivalent to approximately 10-20 hours of video at 640×480 resolution and a video bit rate of 2048 kbps (standard mpeg4 compression), audio at an audio bit rate of 40 kbps, and a video frame rate of 25 fps. Significantly higher recording times may be achieved by using lower quality settings, such as 160×920 resolution (thumbnail), and a 128 kbps video (mpeg4) and 16 kbps audio rates, and 1 fps frame rate. Typical micro-SD cards may also limited to a fixed number of data file names (e.g., 1,000 files on an 8 GB SD card). In use, a miscro-SD card is transferred to (inserted into) a standard SD card that many laptops and other computing devices may receive by inserting the same into a standard SD card slot integrated into the computing device. In another embodiment, the micro-SD card may be transferred to (inserted into) a device having a USB connector for inserting the same into a standard USB port of a computing device. Thus, the data stored on the micro-SD card may easily be transferred to another computing device.

The data input/output communications device 912 provides for inputting information (e.g., data, software updates, etc.) to the PIRD/PRD 702, and outputting information from the PIRD/PRD 702. Live or near real-time streaming of data captured by the device 802 to a remote device (e.g., display) is contemplated, in which case any well-known audio-video streaming software may be used, such as those described at the web site http://www.videohelp.com/tools/sections/video-streaming. The data input/output communications device 912 may be a wire or wireless connection between a user's client device and the firmware and/or run-time software of the PIRD/PRD 702, such that the user may enter preferences via a software application on the client device that causes the firmware/run-time software to be updated.

The internal clock 914 is conventional, and used in conjunction with the microprocessor and other components.

The memory device 916, as needed, may be volatile, non-volatile, or other memory device, in addition to the fixed data storage device 904.

The sensor devices 918 are contemplated as being operatively connected to the PIRD/PRD 702. Thus, they may be physically attached or separate (remote) from the PIRD/PRD 702. A light-level sensor may be used to detect the level of ambient light available at the CCD or CMOS chip. An audio-level sensor may be used to detect the level of sound being recorded. An environmental sensor may provide temperature information to ensure proper operations only during acceptable temperature conditions. An accelerometer sensor may be used to determine the orientation of the PIRD/PRD 702, such that the user is made aware of whether the video being recorded is at an unacceptable angle (i.e., tilted at level that exceeds a pre-determined acceptable angle relative to a reference orientation (e.g., the horizon)). Other sensors are also contemplated.

The remote transceiver communications device 920 may be, for example, a USB-type dongle employing open or proprietary communications protocols (software).

The remote audio device 922 may be, as previously discussed, an ear piece.

All of the above devices are, in operation, operatively and electrically connected to each other, but not necessarily physically connected by a wire (e.g., the remote transceiver 920 and remote audio device 922).

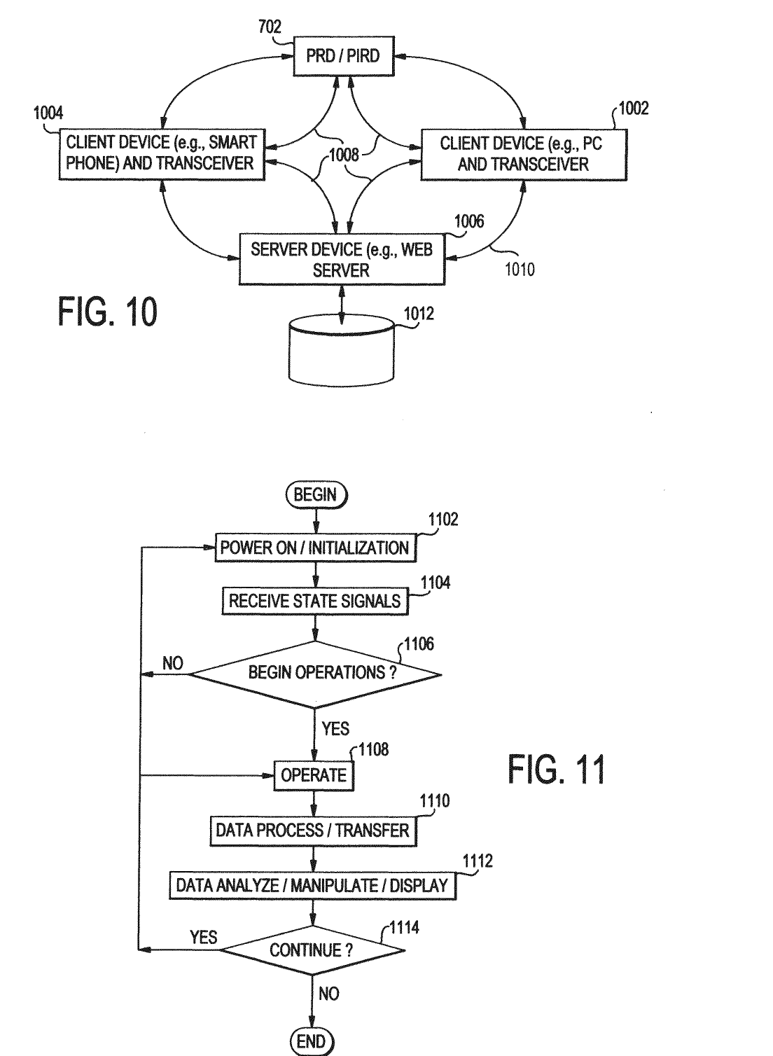

Turning now to FIG. 10, shown therein is a schematic block diagram of additional components of an apparatus in accordance with another aspect of the present invention. In particular, shown are a PRD/PIRD 702, a client device 1002, a client device 1004, and a server device 1006 in data communication with each other over networks 1008 and 1010.

As discussed previously, the audio and video data collected by the PRD/PIRD 702 is stored in memory 916, fixed data storage device 904, and/or removable data storage device 910. Such data may be transmitted to the client device 1004 by way of the one or more networks 1008 and/or 1010. For example, in the case of a smart phone used as a client device 1004, the phone's Wi-Fi or Bluetooth hardware may facilitate transfer of the data from the aforementioned storage devices to the smart phone. An “app” installed on the smart phone could provide the software for interfacing with the smart phone's hardware and operating system to facilitate the data transfer.

Once on the smart phone's storage device, the audio-video data may further be transferred to the server device 1006 and stored on database 1012, indexed and referenced to profile information stored on the database 1012 associated with the user of the PRD/PIRD 702.

Similarly, the data may be transmitted to the client device 1002 by way of the one or more networks 1008 and/or 1010. For example, in the case of laptop computer used as a client device 1002, a suitable transceiver could be used to facilitate transfer of the data from the aforementioned storage devices to the laptop computer. A USB dongle wireless transceiver or USB cable could provide the transfer of data. A software agent installed on the laptop provides the software for interfacing with the USB dongle or USB cable and the laptop's hardware and operating system to facilitate the data transfer. Once on the laptop's storage device, the audio-video data may further be transferred to the server device 1006 and stored on database 1012, indexed and referenced to profile information stored on the database 1012 associated with the user of the PRD/PIRD 702.

Data transfer may be accomplished by any one of the techniques described herein, or using other technology that may be developed and/or adopted in the future. In the present invention, the user is provided the flexibility of selecting how data are transferred, such as using the aforementioned Wi-Fi, Bluetooth d/or micro-SD card, depending on the user's preferences. The microprocessor device 908, firmware, and run-time software may be pre-programmed at the manufacturing stage to a default data transfer method, such as storing data using the micro-SD card (to preserve power). The user may change the default method of data storage to include storage locally on the micro-SD card, with simultaneous and/or buffered wireless transfer via Bluetooth or Wi-Fi. Such preferences by the user may be input using the data input/output communications device 912.

The client device 1002 may have an associated display, such as a high-definition television, such that the data being transferred to the client device 1002 may be projected or display in real-time or near real-time by the display. Such a display could be, for example, a monitor in an operating room that projects video being captured by a surgeon performing a procedure while operating a PIRD 702 attached to a wearable support device 500.

Turning now to FIG. 11, shown therein is a process, data, and operations flow diagram showing various features of another embodiment of the present invention. In process step 1102, the system of devices described above is powered on (or resumes a previous state if in low power “sleep mode”). An initialization process is executed by run-time software that includes, among other processes, uploading and installing current firmware, downloading stored data as necessary to free up storage space, and setting the system devices to a wait or initial state (e.g., PID turned off; PRD turned off, etc.).

In process step 1104, the system of devices described above waits for signals, including signals from the various on/off switches and sensors that inform the software whether to perform any processes. Other signals include a charging signal indicating the energy source is connected to a power source and is being recharged, a low battery signal, and user input signal (e.g., switch pressed), and other status signals (e.g., low light level).

In decision step 1106, a signal indicating the user wishes to conduct operations is received (e.g., a switch is activated to turn on the PID 100 or PRD 702). If no signal is received at decision step 1106, the system may remain in the wait state, or if a prolonged period of time has elapsed, the system may enter the power on/power off/sleep/initialization state.

Depending on the signal received, in process step 1108, the PID 100 is turned on, including the light source, or the PRD/PIRD 702 is turned on. An audible signal may be generated and sent to the remote earphone.

In process step 1110, the data collected by the video camera is process and stored, and the run-time software monitors the status of the various devices. The data input/output communications device outputs (transmits) data to one of the client devices previously described, or the recorded data are processed (e.g., compressed, transposed, converted, indexed, etc.), and then transferred. That is, the data may be downloaded via wired or wireless protocol to the client devices previously described. A client “app” or application, or web applications may be launched to facilitate processing the data to view, manipulate, share, and further transfer the data by the user.

In process step 1112, the data may be further analyzed by the user, manipulated (e.g., cropped or augmented), and displayed (e.g., on a user's web site).

In decision step 1114, the system continues to operate or, if a signal is received by the run-time software, the system reverts to previous steps in the process, including the power off/sleep mode, or wait mode as previously described.

In operation, the PID, PIRD, and/or PRD of the present invention may be used in a number of different ways, many of which are previously suggested. In the case of a surgeon, for example, the wearable support device 500, in the form of a surgical cap with the surgeon's personal name, practice name, hospital name, logo, or other information displayed on the wearable support device 500, may be acquired or checked-out from inventory prior to use. The cap may replace or augment the standard loupes head gear, and provide the same and additional functionality. The PID, PIRD, and/or PRD may have been pre-programmed with certain functions based on user (at time of ordering) or pre-determined (manufacturer-specified) preferences. Those preferences may be updated, as described above, by the user prior to use. The surgeon may prefer, for example, to use the PIRD (assuming the particular device is so equipped) with the light source at a narrow focus because the particular surgical procedure he or she will be performing involves a small area. The surgeon may also prefer to set the audio microphone to a level that only captures his own and other's voices nearby. The surgeon may also prefer to set the video camera such that it records high-definition video, records the video on the micro-SD card, and automatically streams the video data as a signal via a wire, or wirelessly via Bluetooth or Wi-Fi to a remote computing device and a wall-mounted display for teaching purposes. All of those, and other preferences, may be input using the input/output communications device, as previously discussed. During the procedure, the surgeon may find that the light is too bright and may not cover a sufficient area, and thus may wish to change the light level from “high” to “low” (or may decide to turn the light source to “off”), or adjust the width of the beam of light from narrow (spot light) to wide (flood light), or some setting in between, which may be accomplished by activating one of the switches on the wearable support device 500. Likewise, the surgeon may find that the audio level is too low to capture the sound from an anesthesiologist or nurse in the operating room, and may thus adjust the sound level up to capture sounds farther from the microphone. Also, the surgeon may find that the video is not focusing well, and may engage the auto focus feature (provided via software or moveable lens). After the procedure, the surgeon may find that the surgery went well and would like to take a copy of the video, and so removes the micro-SD card from its slot and places it in his or her computing device to review. Using the software provided with the wearable support device 500, the surgeon is able to view the data, crop unnecessary portions, create video files, and transfer those files to others (e.g., colleagues, the patient, insurers, educators, hospital administrators, etc.). The above scenario is illustrative only, and not intended to limit the features and advantages of the present invention to those described.

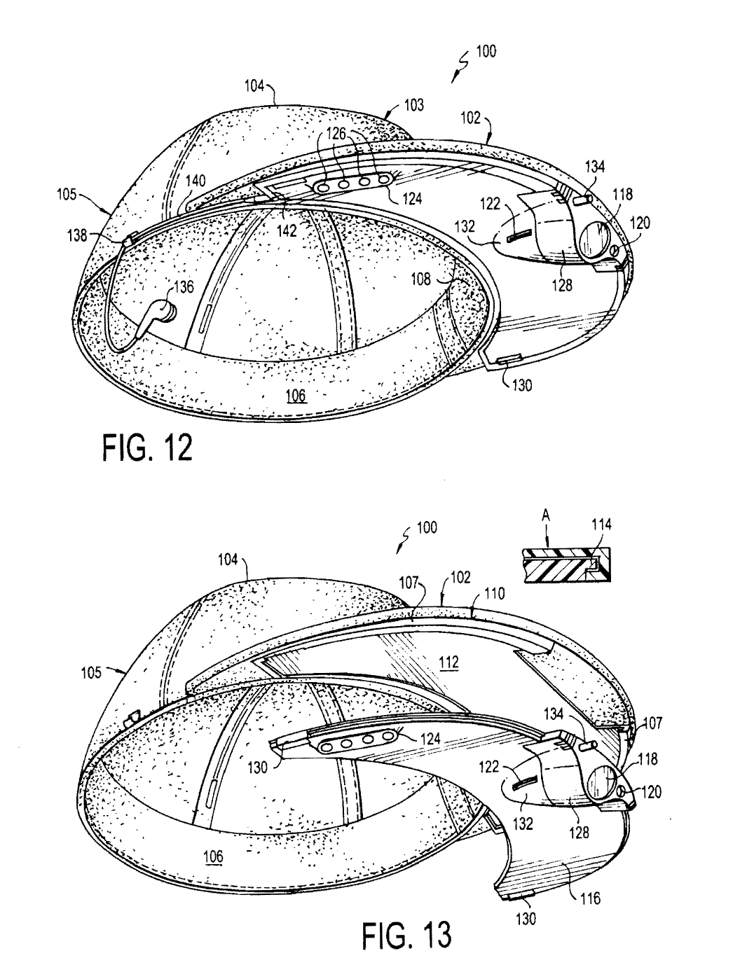

Turning now to FIG. 12 through FIG. 20, additional embodiments of the present invention are shown. In FIG. 12, a wearable PIRD 100 in the form of a baseball-style cap is shown (although the device could, instead, be a PID or PRD, as previously defined; however, for illustration purposes a PIRD is shown and described). The PIRD 100 generally includes a brim 102 and crown portion 104 for fitting over the user's head, as described below.

In one embodiment, the crown portion 104 has a front side 103 and a back side 105 and a size-adjustable, flexible, an moisture-wicking band 106 extending along its edge from the front side to the back side so as to ensure that the PIRD 100 may fit all users. Preferably, the front of the crown portion 104, which rests adjacent to the user's forehead, is formed of a shape-memory material 108 so as to contour to the shape of the user's forehead and allow for an optimal fit. As set forth below, the shape-memory material 108 also helps to ensure that the optional at least one light source 118 and/or audio/video recording device 120 of the PIRD 100 faces the same orientation as the user's head when these components are in use. The crown portion may be personalized with indicia or attachments to portray the name of the user of the PIRD 100 or the user's preferences, affiliations, associates, employer, etc. (such as a favorite team name or logo, or an employer name).

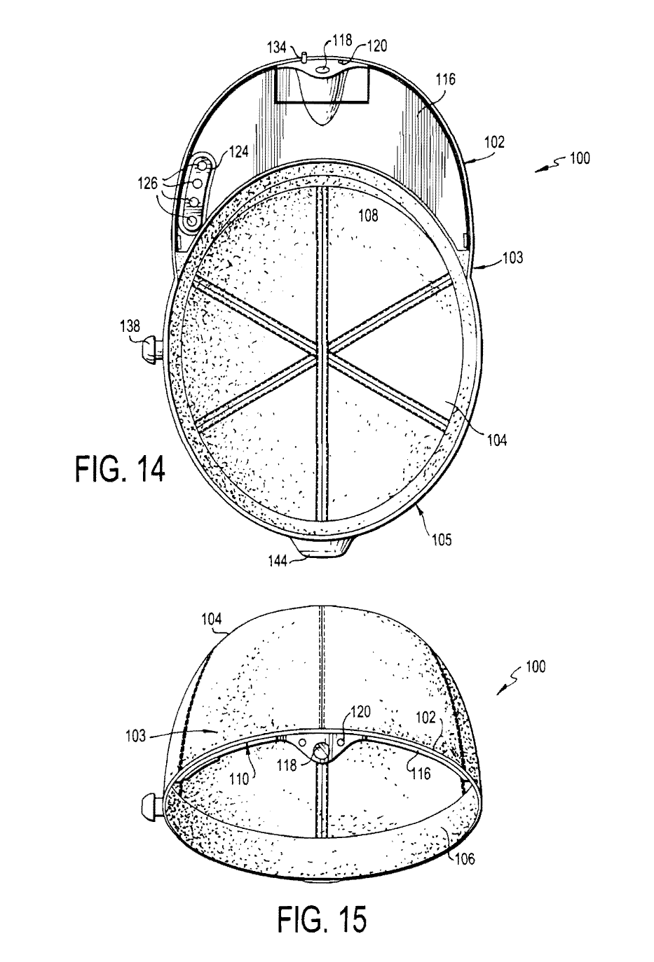

As shown in FIGS. 13 and 14, the brim 102 extends from the crown portion 104. In one embodiment of the invention, the brim 102 may be detachable from the crown portion 104 so as to be serviceable or replaceable.

The brim 102 has an underside 110 to which a rigid support 112 may be coupled. The rigid support 112 generally takes the shape of the brim 102 so as to fit securely and aesthetically underneath it. The rigid support 112 may be permanently attached to the underside 110 of the brim 102, such as by use of a sewing technique or an applied adhesive. In other embodiments, the rigid support 112 may be removably attached to the underside 110 of the brim 102, such as with Velcro®, clips, snaps, other forms of friction fitting, buttons, and similar devices known in the art.

The rigid support 112 is formed of a water-safe material, so that the PIRD 100 with the rigid support 112 coupled thereto may be washed together. For example, the rigid support 112 may be made from a rigid or flexible sewable plastic or textile material.

The rigid support 112 has two side edges 107, each of which have a channel 114 formed therein, such as the J-shaped channel illustrated in the zoomed-in portion A of FIG. 13. The channels 114 are designed to receive a brim-shaped housing 116. The brim-shaped housing 116 may slide into channels 114 such that it may be coupled to the underside 110 of the brim 102, parallel and adjacent to the rigid support 112. The brim-shaped housing 116 is preferably positioned under the brim 102 so as to protect the electronics (discussed below) housed within from environmental conditions (e.g., water).

The brim-shaped housing 116 may include at least one releasable attachment piece 130 that ensures that the brim-shaped housing 116 is secured to the rigid support 112 when in use and does not slide out or inadvertently loosen while the user is wearing the PIRD 100. The at least one releasable attachment piece 130 may be selected from a clip, snap, other form of friction fitting, button, and any other releasable mechanism known in the art.

All of the materials used to compose the brim 102 and crown portion 104 are preferably waterproof or at least water resistant, in addition to being resistant to other liquids one might encounter in, for example, a medical treatment facility, and, more specifically, in a surgical room of a hospital.

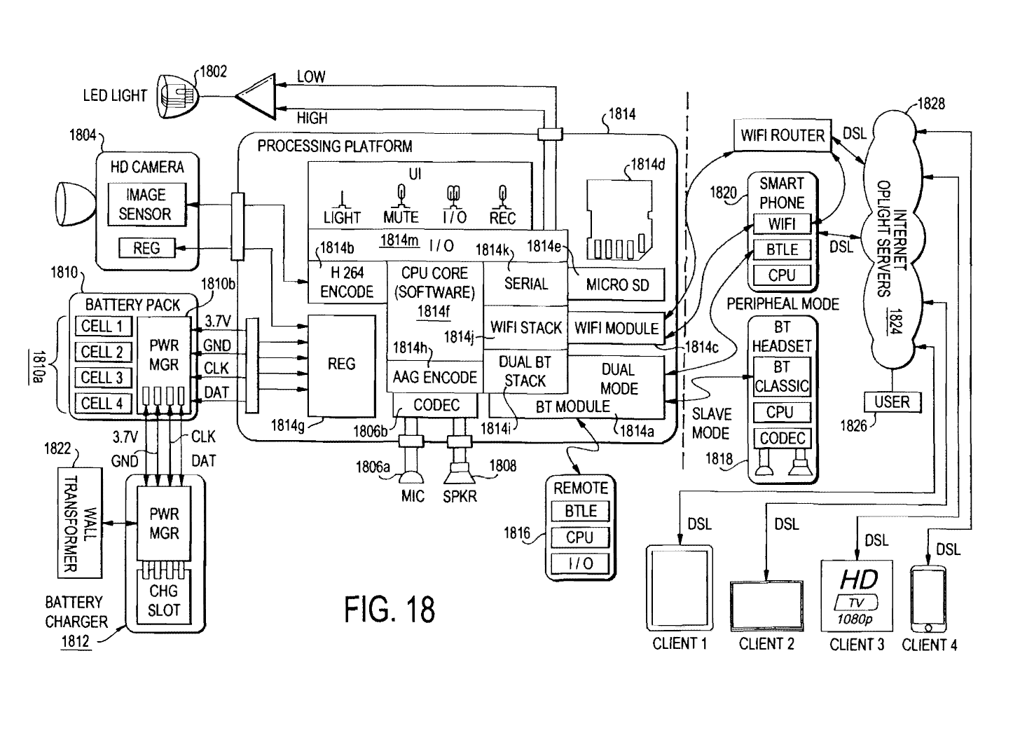

Referring back to FIG. 12 and also to FIG. 18, the brim-shaped housing 116 may house or support various electronic components, including, but not limited to, an optional at least one light source 118, an audio/video recording device 120, a storage device slot 122, a microphone, a control panel 124, a wireless network Wi-Fi antenna, one or more indicator lights 126, and at least one circuit board.

The brim-shaped housing 116 preferably extends along the entire length of the brim 102. The brim-shaped housing 116 may be formed of lightweight aluminum, which provides adequate mechanical strength and heat dissipation and does not weigh down the brim 102. In one embodiment, the brim-shaped housing 116 is coated or covered with a suitable material so that the aluminum used to make the brim-shaped housing 116 is not exposed and for aesthetic purposes. The coating or covering material is preferably one that does not impede convective heat dissipation. All of the materials used to compose the brim-shaped housing 116 are preferably waterproof or at least water resistant, in addition to being resistant to other liquids.

One or more of the above-listed components may be positioned in the light/camera housing 128, which may be part of or integral to the brim-shaped housing 116, or it may be a separate housing that is attached to the brim-shaped housing 116. The light/camera housing 128 may instead be formed as an integral part of the rigid support 112 or it may be removably attached to the rigid support 112 to allow for servicing and/or replacing separately from the brim-shaped housing 116.

The light/camera housing 128 may include a knob 134 that the user may grasp in order to adjust the at least one light source 118 (if present) along a plane, such as the saggital line of the brim 102, so as to be able to illuminate objects in different vertical locations in front of the user. The knob 134 is large enough that it may be easily grasped by the user, but not so large that it would obstruct the user's view or decrease the aesthetic value of the personal illumination/recording device 100.

The optional at least one light source 118 and audio/video recording device 120 may be housed within the light/camera housing 128. According to one embodiment, the PIRD 100 may be a PRD and include only an audio/video recording device 120 (i.e., no light source 118). According to another embodiment, the PIRD 100 may be a PID and includes only a light source 118 (i.e., no audio/video recording device 120).

As illustrated in FIG. 15, the light/camera housing 128 may be positioned at the front of the brim 102 such that it faces out toward the front of the user. While not limited to such an embodiment, the audio/video recording device 120 is preferably a high-definition video camera.

A microphone (not shown) may be coupled to the brim-shaped housing 116 in any location to provide concentrated audio signals to be captured by the audio/video recording device 120. As previously discussed, the microphone may be connected to the audio/video recording device 120 via hardwire. The wireless network Wi-Fi antenna (discussed below) may also be coupled to the brim-shaped housing 116 in any location for connecting to a wireless network to transmit audio/video signals in real-time, or those that have been previously recorded, according to the methods discussed herein. In this embodiment, the control panel 124 may include a Wi-Fi indicator light 126 (as discussed below) so that the user (and those individuals in his/her vicinity) can easily discern when the PIRD 100 is connected to a wireless network.

The storage device housing 132 is positioned behind the light/camera housing 128, closer to the forehead of the user. Like the light/camera housing 128, the storage device housing 132 may be formed as an integral part of the rigid support 112 or it may be removably attached to the rigid support 112 to allow for servicing.

The storage device housing 132 includes a storage device slot 122 for receiving a removable storage device (as best seen in FIG. 18), such as a micro-SD card. The micro-SD card, as previously discussed, is capable of storing data, and may preferably have a capacity of 8 GB.

The control panel 124 may be located anywhere on the brim-shaped housing 116 or other location such that it is easily accessible to the user. As shown in FIGS. 12 and 13, the control panel 124 may include at least one indicator light 126. The indicator light(s) 126 correspond to the various functions of the PIRD 100, including recording, transmitting, battery life, etc. For example, one of the indicator lights 126 may illuminate red to indicate to the user that the PIRD 120 is turned on and the user is recording. Another of the indicator lights 126 may illuminate blue to indicate to the user that the WiFi is turned on and the user is recording and transmitting audio/video data. Another of the indicator lights 126 may indicate where data is being stored and/or transmitted, such as to indicate data is being stored locally on the micro SD card 1814d or is being transmitted wirelessly. Any number of indicator lights 126 may be used according to various embodiments of the invention. Additional indicator light(s) 126 may also be positioned at the front of the PIRD 100, as depicted in FIGS. 12 and 13. In this way, individuals in the user's presence may also know when the user is recording, transmitting, etc.

The PIRD 100 also includes at least one circuit board (as discussed in more detail below), such as a printed circuit board, which is within the brim-shaped housing 116. A flexible circuit board may be used to ensure that the brim 102 of the PIRD 100 may be flexed or adjusted according to the needs or preferences of the user. The at least one circuit board controls all of the electronic components housed within or supported by the brim-shaped housing 116, as discussed further below.

The PIRD 100 may also be equipped for two-way communications by, for example, including at least one ear bud 136 so that the user may listen to feedback transmitted from an outside source or hear the audio being picked up by the microphone 1806a (see FIG. 18). For example, one feature of the PIRD 100, as set forth herein, is a PRD (audio and video) that can transmit whatever is being recorded to another computer or display. The PIRD 100 may receive audio feedback from individuals watching the transmitted recording, such that two-way audio is established. This would be useful for surgeons, for example, during question and answer sessions while performing an operation.

The at least one ear bud 136 may be removably attached to the side of the crown portion 104 of the personal illumination/recording device 100 by an ear bud attachment piece 138. The attachment piece 138 may be a clip, clasp or hook that secures the ear bud wiring 140 to the personal illumination/recording device 100 so that the ear bud 136 is not lost and is out of the way of the user. The ear bud wiring 140 may be electrically connected to the brim-shaped housing 116 at electrical port 142. The port may be positioned at the back of the brim-shaped housing 116 (i.e., at the front side of the crown portion 104) so that the ear bud wiring 140 need only extend along the side of the crown portion 104 and not across the brim 102.

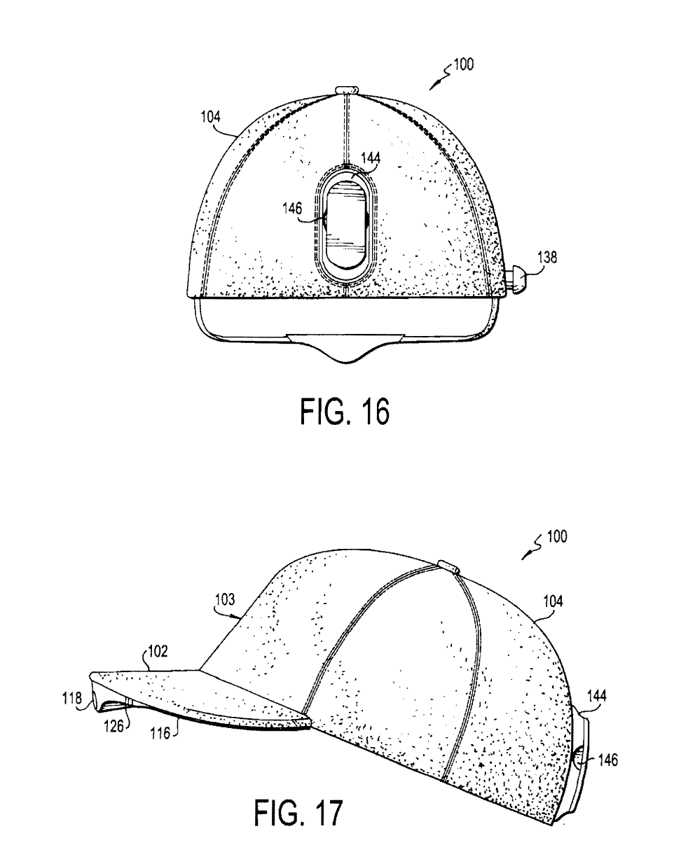

Turning now to FIGS. 16 and 17, shown therein are additional perspective view drawings of a PIRD 100, which include an energy source housing 144, which stores at least one energy source, such as a battery 146. The battery 146 within the energy source housing 144 is electrically coupled to the electrical components housed within or secured to the brim-shaped housing 116 (as best seen in FIG. 18, described below).

The combined weight of the energy source housing 114 with batteries installed may be slightly greater than the combined weight of the brim 102, the rigid support 112, the brim-shaped housing 116, light/camera housing 128, and all of the other electrical components previously described as being part of those components. The purpose of such a weight distribution is to provide the user with the sensation that the PIRD 100 is secure and stable when donned, and also to increase the chance that the PIRD 100 lands on the back side of the PIRD 100 rather than on the brim side should it be dropped.

Where the brim 102 is detachable from the crown portion 104, the power connection is also detachable using electrical coupling techniques well known in the art.

In a preferred embodiment, the batteries may be rechargeable lithium ion or lithium polymer batteries with a two-hour or four-hour battery life. For example, the batteries may be 4.8 Ahr batteries having full four-hour capability at 1.2 A current consumption.

The batteries may be recharged using a standard wall transformer battery charger, which reduces UL testing requirements. The battery charger may have an on-board printed circuit board with charge management circuits to reduce battery pack heating. The charger preferably has a charge rate of 1 C (4.8 A).

Referring now to FIG. 18, shown therein is a schematic diagram showing various electrical and networking components of the PIRD 100 according to the present invention. Shown is an LED light source 1802, an HD (high definition) video recording device 1804, an audio recording microphone device 1806, a speaker 1808, a battery pack 1810, a battery charger 1812, a processing platform 1814, and a remote control unit 1816. Each of these components will be discussed below.

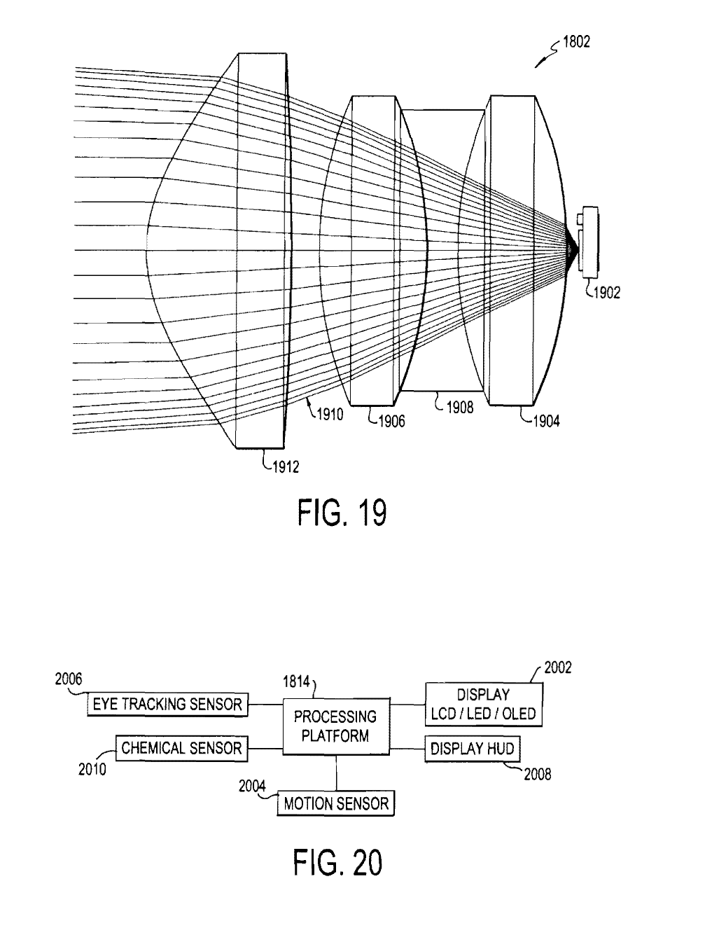

The LED light source 1802 is preferably a spotlight formed of four separate lenses projecting light from an LED light source, as best seen in FIG. 19. The LED 1902 may be, for example, a Luxeon Z™ with a 4700K color contrast (CCT) and 80 color rendering index (CRI). Such a device may use about 2.1-Watts of power (about 0.7-A constant current drive from a 3-Volt direct current driver), and have multiple level of output (typically full and half power). The LED 1902 outputs about 200 lumens with a range of about 16,000 to 18,000 lux luminance. The LED 1902 may produce a spot size of about 18 inches at about 2-5 inches across (full width half maximum) and can operate preferably at two light levels, such as full power and half power.

The lenses 1904 and 1906 are preferably high index of refraction lenses, such as Schott Bi-Convex Lens pairs. The lens 1908 is a low index of refraction lens, such as Dow Corning Corporation MS-1002 Bi-Concave Lens, made of a moldable optical silicone, or a PMMA lens. The three lenses 1904, 1906, and 1908, are arranged in the opposite functional order of a traditional Hasting's Triplet. An air space 1910 separates the lens 1906 from the projecting lens 1912. In a preferred embodiment, the LED light source 1802 is approximately 0.75 inches in diameter, 0.5 inches in length, and weighs approximately 35 grams.

The video recording device 1804 is preferably an auto-focusing, dynamic contrasting, high definition camera. The field of view of the video recording device 1804 is preferably 23 inches in diameter at a distance of 18 inches from the user. Mechanically, the video recording device 1804 preferably has a dimension of about 0.5-inches diameter and 0.5-inches in length, and weighs less than about one ounce, although other sizes and weights are available. It may require about 100-mA current, operating under a voltage of, for example, 1.8-Volts, 2.5-Volts, or 3.0-Volts. In terms of resolution, the video recording device 1804 may be equipped so as to provide 1080 p (progressive) lines of resolution (high definition) at 30 frames per second equivalent capture rate, though any resolution and frame rate may be used. Optically, a 10-centimeter to infinity focal range is preferred, using a variable focus lens, with a f-2.2, and having about a 66-degree through the lens field of view relative to the projecting axis.

In terms of software and data processing, the video recording device 1804 may be connected to a video data encoder 1814b on the processing platform 1814, which converts image data from the video recording device 1804 using an MPEG-4 or H.264 coder-decoder (CODEC) protocol. The variable-focus lens is auto focusing using hardware and/or software techniques well known in the art. “Stills” made from the image data from the video recording device 1804 may be generated at, for example, 5-mega pixel (MP) resolution.

Streaming of video image data wirelessly via a Wi-Fi protocol may be facilitated by a Wi-Fi module 1814c (and may be simultaneously streamed to the SD card 1814d via a micro SD card slot 1814e, along with streaming audio).

An audio recording device 1806 may include a microphone 1806a, and CODEC 1806b for data encoding/decoding and subsequent streaming. In one embodiment, the audio stream from the audio recording device 1806 may be time-synchronized with the video data using a software platform. Such processing requires the use of a micro-transceiver for audio. Audio may be streamed to the ear bud 136 via Wi-Fi/Bluetooth or h.264 protocols. Pairing to the ear bud 136 via Bluetooth preferably requires a password entry, which can be done via a smart phone app (discussed below). A dual-mode Bluetooth module may also be used, but two separate modules, such as BTLE and BT classic may also be used. BTLE pairing does not require password entry, but may require device selection (again, via the smart phone). A low power/low bandwith protocol, or H.264, may also be used to sync the audio and video data streams.

Using so-called “near field communications” or low-power, low bandwidth protocols may also be used in addition to, or instead of, one or more of the Wi-Fi, Bluetooth, and h.264 communications protocols.

The energy source housing 144 preferably houses a battery pack 1810, having four battery cells 1810a arranged in one or two rows, although other numbers and arrangements of battery cells are also contemplated. The energy source housing 144 is preferably positioned (e.g., vertically or horizontally) on the back of the crown portion 104 of the PIRD 100. The backside of the energy source housing 144, i.e., facing the user's head, is preferably concave or arcuate to contour to the shape of the user's head. The energy source housing 144 may be formed of a flexible elastomeric or other material which can be sewn in order to attach the energy source housing 144 to the crown portion 104.

Assuming an estimated total current draw of about 1.2-A, the battery pack 1810 should provide about 4-hours of operating time. Assuming an estimated current draw of about 0.75-A, for example when the LED light source 1802 is operating at half intensity or other components are not in use, the battery pack 1810 should preferably provide about 6-hours of operating time. More or less operating time may be provided depending on the various preferences of the user. Given all considerations, the battery pack 1810 should have a preferred total battery capacity of about 4.8-Ahr.

The power management module 1810b, which is contained on an integrated printed circuit board inside the battery pack 1810, monitors over/under voltage, short circuits, and operating temperature, and outputs a signal indicative of the battery charge level to an indicator on the battery pack (e.g., an LCD, green/yellow/red LEDs, etc.).

The energy source housing 144 may include at least one indentation 146 on either side to permit gripping the sides of the battery. When the batteries are ready to be swapped or replaced, the user may grip the sides of the batter at the indentation(s) and pull the battery out. As set forth above, the user is notified when the batteries are running low by illumination of one of the indicator lights 126 positioned on the control panel 124 or at the front of the brim-shaped housing 116.

The brim-shaped housing 116 may also house a separate and independent battery (not shown) that may be used to power the electronic components of the brim-shaped housing 116 while the battery pack 1810 in the energy source housing 144 is being replaced. This independent battery may power the components for up to several minutes and is preferably a rechargeable lithium-ion battery as described herein.

A battery charger 1812, along with a wall transformer 1822, provides a preferred single charge rate of about 4 hours (i.e., 4.8-Ahr, assuming that as the design capacity of the battery pack 1812). The wall transformer 1822 provides for AC/DC conversion. The wall transformer 1822 could also be connected directly to the battery pack 1810 to supply direct charging capability without the need for a separate battery charger 1812.

The processing platform 1814 includes the major electronic/electrical components and embedded software/firmware of the PIRD 100, and includes: a high bandwidth wireless protocol transceiver module 1814a, an audio CODEC 1806b, a video data encoder 1814b, a Wi-Fi module 1814c, a SD data storage card 1814d (when the card is inserted), a micro SD card slot 1814e, a central processing unit (CPU) 1814f, a voltage regulator 1814g, an AAC encoder 1814g, a dual mode BT module 1814i, a Wi-Fi stack module 1814j, a serial module 1814k, an input/output module 1814m, and a memory device (not shown). Other modules, stacks, individual chips, and related software may also be included on the processing platform 1814. The processing platform 1814 components may be arranged on a platform having a dimension of about 1-inch wide and 2-inches long, and about 3-millimeters thick, and weigh less than about 0.5 ounces, but those dimensions and weight may change as necessary. The platform may be rigid or semi-rigid (flexible), depending on the size of the chips.

Preferably, the processing platform 1814 consumes less than about 400-mA, and the voltage regulator 1814g provides about 4.2-Volts, outputted at about 1.8-Volts, 2.5-Volts, and 3.1-Volts, or as needed to support the operation of the various electrical components in different modes of operation.

The wireless protocol transceiver module 1814a, which preferably operates at a relatively high-bandwidth, including, but not limited to, Bluetooth, preferably runs in dual mode to support wireless devices. The wireless devices supported may include, for example, the remote control device 1816, a remote headset 1818, and a remote smart phone 1820. Instead of a single wireless protocol transceiver module 1814a, two (or more) separate single mode/channel modules could be used.

In the case where Bluetooth is used, a Bluetooth Classic protocol may be used to stream audio to the remote headset 1818. As is known, the two devices would need to be paired for communications to be effected. The dual mode BT module 1814i works with the wireless protocol transceiver module 1814a.

Due to the latent delay between a streaming video image and a live image (and sound) captured by the video recording device 1804 (and microphone 1806a), the present invention incorporates software to account for the delay (which is caused by, for example, H.264 encoding, processing buffering on the processing platform, server side memory buffering, H.264 decoding, and network bandwidth limitations). Audio is preferably time synchronized with video. High definition video data may be encoded from 1080 p to h.264 at 60 frames per second and streamed to Wi-Fi and the SD card 1814d via the SD card slot 1814e simultaneously, along with audio.

The AAC encoder 1814h encodes data using, for example, the MP3 data compression protocol.

With regard to on-board memory, preferably sufficient memory is included to accommodate the various software and data storage needs, for example, the wireless protocol transceiver module 1814a, the video data encoder 1814b, and the Wi-Fi module 1814c. A 64-bit, LP-DDR2 interface memory module (not shown) may be used.

In at least one embodiment, the PIRD 100 may be operated by a key fob-like remote control 1812. The remote control 1812 may be used to operate all of the electronic components of the PIRD 100, including the LED light source 1802, the video recording device 1804, the microphone 1806a, and the various wireless components previously described. For example, the remote control 1812 may be used to turn the LED light source 1802, the video recording device 1804, the microphone 1806a, and the speaker 1808 on and off, provide volume and light level control, pairing with wireless modules, and allow the user to select to record locally (i.e., to the micro-SD card 1814d) or to record and transmit to a remote recipient.

The remote control 1812 may have a display screen (not shown) that informs the user how much battery life remains in the battery pack 1810, and may have buttons the user can select to control the functions of the PIRD 100. This function is useful, for example, where a surgeon may have already scrubbed in to surgery, such that a nurse located outside of the operating room may control the PIRD 100 remotely.

The remote control 1812 preferably also has its own battery (not shown), which could dictate the size of the remote control 1812. Battery life of the remote control 1812 will depend on the responsiveness of the buttons (connection rate), number of uses (presses) per year, and battery size, which are variables well known in the art.

Turning now to FIG. 20, shown therein is a schematic block diagram of additional components of the PIRD 100, including a display 2002,

In one embodiment, the processing platform 1814 may be equipped with appropriate electronic devices and software to support a separate display 2002 attached to, for example, the brim-shaped housing 116 to provide the user with a “through-the-lens” view of what the video recording device 1804 is “seeing.” The display 2002 may be physically coupled to the brim-shaped housing 116 so as to be easily viewable and adjustable by the user, and electrically coupled (either by wire or wirelessly) to the CPU 1814f. The display 2002 could be used to show the user exactly what he or she is recording in real time, or to stream live video feed from an external source, such as video data from a separate PIRD 100 operated by another user. The display 2002 could be adapted with a capacitive touch-screen, such as a touch screen on the smart phone 1820, to allow the user to operate the various functions of the PIRD 100 from the display using tactile input.

In yet another embodiment, the processing platform 1814 may be equipped with appropriate electronic devices and software to support a motion sensor 2004 attached, for example, to the brim-shaped housing 116. The motion sensor 2004 preferably provides motion detection and tracking. The sensor 2004 will detect motion around the user. Motion tracking will be synchronous with the motion of the PIRD 100, the user of the PIRD 100, or some other reference object (mobile or stationary). The motion sensor 2004 detects motion relative to one of those reference points, and may be independent of the field of view of the audio/video recording device 120 or video recording device 1804. That is, the field of view of the motion sensor 2004 may be different than the current field of view of the video devices, such that the motion sensor 2004 causes a signal to be sent to the CPU 1814f, which in turn causes the field of view of the video devices to change to capture images of the motion in near real time (as either still or video format). The motion sensor 2004 may be equipped with an infrared sensor to detect motion by detecting relative or contrasting thermal sources in the field of view of the motion sensor 2004.

In yet another embodiment, the processing platform 1814 may be equipped with appropriate electronic devices and software to support an eye tracking sensor 2006 attached, for example, to the brim-shaped housing 116. Preferably, the eye tracking sensor 2006, which may be a backward-mounted camera, is mounted under the brim-portion of the PIRD 100, and will detect the user's eye movements using software. The eye tracking sensor 2006 may work in concert with the display 2002. The eye tracking sensor 2006 outputs a signal to the CPU 1814f, which in turn causes the audio/video recording device 120 or video recording device 1804 to adjust such that the field of view of the video devices is synchronous with the direction the user's eye moves. Thus, when a user is recording a specific task and does not wish to move his or her head, but at the same time wishes to capture something else, for example, in the user's peripheral vision, the audio/video recording device 120 or video recording device 1804 may be used to capture whatever the user glances at.

In yet another embodiment, the processing platform 1814 may be equipped with appropriate electronic devices and software to support a heads-up display 2008 attached, for example, to the brim-shaped housing 116. Similar to the display 2002, the heads-up display may provide an image of what the audio/video recording device 120 or video recording device 1804 is “seeing” in real time by projecting the image onto a screen and/or any other remote display.

In yet another embodiment, the processing platform 1814 may be equipped with appropriate electronic devices and software to support a chemical sensor 2010 attached, for example, to the brim-shaped housing 116. The chemical sensor 2010, which may be made up of several separate sensors, may be used to output an alert (audible or visible) to the user of the PIRD 100 if it senses pre-determined gases, fumes, aerosols, particulates, radiation, and other materials above detectable levels. The sensor 2010 would preferably operate in a passive or active mode (using a remote pump, not shown), or both, to collect substances in the environment near the user. Chemical-detecting sorbents and other detectors useful in conjunction with the chemical sensor 2010 are well known in the art.

Other sensors (not shown) may also be used to detect, for example, physiological states of the user of the PIRD 100, such as the position of the user's head, skin temperature, pulse rate, etc.

Those skilled in the art will appreciate that the many components of the PIRD 100 do not have to be assembled in the manner shown and described. Other form factors may be used, such as a wearable vest, and certain components of the PIRD 100 may be remote from other components. Such a system could, for example, place one or more of the components of the PIRD 100 on a person's clothing, accessories, or equipment.

The present invention also includes a client-side and server-side application to provide for the maintenance and storage of user accounts, user content, and distribution of content, among other functions. The application may enable a cloud-based platform and communications applications. Those functions are facilitated by the servers 1824 and user client device 1826.

The server-side application may be, for example, an application for serving a website on the client device 1826, which is displayed by a browser running over the Internet. Locally, on the client side, a separate application or browser plug-in may also perform certain server-side processes, such a local storage of data, editing of video and audio, and other functions prior to transferring to the server. The local or client-side application may also be an application running separately on the smart phone 1820 (mobile phone app) for remote access to the server. The local application on the smart phone 1820 may synchronize with the local application on the client device 1826 via the cloud-based (Internet) 1828.

The server 1824 may maintain user accounts, including user-specific information (such as preferences), user files (such as video files), and other user files, on a suitable storage device and using a suitable database structure. The server 1824 may also include a software agent for handling multiple audio/video feeds from several different PIRD 100 devices, and coordinate outputting those displays over communications channels to one or more display devices, such as a television or computer monitor. In this way, one or more persons, who are remote from several users at a particular location each having their own PIRD 100, may view activities at the location by looking at the display device. This multi-point of view synchronization of video and audio on a single display screen could be useful, for example, in a law enforcement or emergency response situation where a person in authority (e.g., police or medical personnel) is able to view all angles of the scene, collect visual data, and coordinate on-scene activities (through two-way communications by broadcasting audio over the speaker 1808 or wireless headset 1818 of each person at the scene.

The server and client software will require initial account setup to establish connectivity channels between the user's devices (e.g., the smart phone 1820 and the user's client device 1826).

The above and other object, advantages, and features of the present invention will be apparent to those skilled in the art from the foregoing specification. Accordingly, it will be recognized by those skilled in the art that changes or modifications may be made to the above described embodiments without departing from the broad inventive concepts of the invention. For example, features detailed as included in certain specific embodiments above are recognized as interchangeable and possibly included in other detailed embodiments. Specific dimensions of any particular embodiment are described for illustration purposes only. An individual component of a larger assembly may be remote from the rest of the components. It should therefore be understood that this invention is not limited to the particular embodiments described herein, but is intended to include all changes and modifications that are within the scope and spirit of the invention.

What is claimed is:

1. A wearable personal illumination/recording device comprising:
a crown portion for fitting over a user's head, the crown portion having a front and back side;
a brim extending from the front side of the crown portion, the brim having an underside and a front portion and optionally detachable from the crown portion;
a rigid support coupled to the underside of the brim, the rigid support having two side edges each having a channel formed therein;
a housing coupled to the rigid support;
a light/camera housing coupled to the housing and positioned at the front portion of the housing and brim;
an audio/video recording device housed in the light/camera housing for collecting, storing, manipulating, and transmitting audio and video data over at least one communications channel;
a light outputting device housed in the light/camera housing for outputting light; and
an energy source housing electrically coupled to the housing having an energy source for supplying energy to the audio/video recording and light outputting devices.

2. The wearable personal illumination/recording device of claim 1, wherein front side of the crown portion is formed of a shape-memory material.

3. The wearable personal illumination/recording device of claim 1, wherein the housing includes at least one releasable attachment piece to secure the housing to the rigid support.

4. The wearable personal illumination/recording device of claim 1, wherein the housing is entirely positioned beneath the brim.

5. The wearable personal illumination/recording device of claim 1, wherein the housing includes a knob positioned at the front portion of the brim for adjusting the at least one light source along a saggital line of the brim.

6. The wearable personal illumination/recording device of claim 1, wherein the at least one light outputting device comprises in series an LED light source, a first double-convex lens spaced from the LED light source, a double-concave lens spaced from the first lens, a second double-convex lens having the same refraction as the first lens and spaced from the double-concave lens, and a fourth projector lens spaced from the second lens.

7. The wearable personal illumination/recording device of claim 1, wherein the audio/video recording device is a high-definition video camera.

8. The wearable personal illumination/recording device of claim 1, further comprising a storage device housing coupled to the housing or the light/camera housing and positioned behind the light/camera housing; and a storage device slot for receiving a removable storage device.

9. The wearable personal illumination/recording device of claim 1, further including one or more wireless data transmitting devices for transmitting live or previously-recorded audio and/or video data to a remote display or recipient.

10. The wearable personal illumination recording device of claim 9, wherein the live or previously-recorded audio and/or video data are saved to a removable storage device or simultaneously saved to the removable storage device and transmitted to an external display or the remote display over a wireless network.

11. The wearable personal illumination/recording device of claim 1, further comprising a microphone.

12. The wearable personal illumination/recording device of claim 1, further comprising a control panel electrically connected to the audio/video recording device and the light outputting device and having at least one indicator for outputting indicia indicative of a present function of the personal illumination/recording device.

13. The wearable personal illumination/recording device of claim 1, further comprising at least one indicator light located on the housing at the front portion of the brim for outputting indicia indicative of a present function or operating status of the personal illumination/recording device.

14. The wearable personal illumination/recording device of claim 1, wherein the housing contains at least one processing platform comprising:
a microprocessor;
a voltage regulator;
an input/output device;
at least one connection for one of a microphone or speaker; and
at least one module for wireless connection for one of a remote control, headset, or smart phone.

15. The wearable personal illumination/recording device of claim 1, further comprising at least one ear bud speaker attached to the crown portion via an ear bud attachment device.

16. The wearable personal illumination/recording device of claim 15, wherein the speaker is capable of receiving and outputting audio produced by a remote source.

17. The wearable personal illumination/recording device of claim 1, wherein the energy source comprises at least one removable and rechargeable lithium-ion or lithium-polymer battery, and wherein the energy source housing includes at least one exterior surface shaped to conform to the shape of a portion of a human head.

18. The wearable personal illumination/recording device of claim 1, wherein the energy source housing includes two cutouts for facilitating gripping and removing the energy source.

19. The wearable personal illumination/recording device of claim 1, further comprising a lithium-ion battery housed within the housing to provide power when the energy source is removed from the energy source housing.

20. The wearable personal illumination/recording device of claim 1, further comprising a wirelessly connectable remote control device for wirelessly controlling at least one function of the personal illumination/recording device.

21. The wearable personal illumination/recording device of claim 1, further comprising a display screen coupled to the light/camera support structure for viewing by the user.
